SEQUENCE LISTING (4 sequences)

SEQ ID NO: 1 - protein, 375 aa, Homo sapiens
MEEEIAALVIDNGSGMCKAGFAGDDAPRAVFPSIVGRPRHQGVMVGMGQKDSYVGDEAQSKRGILTLKYPIEHGIVTNWDDMEKIWHHTFYNELRVAPEEHPVLLTEAPLNPKANREKMTQIMFETFNTPAMYVAIQAVLSLYASGRTTGIVMDSGDGVTHTVPIYEGYALPHAILRLDLAGRDLTDYLMKILTERGYSFTTTAEREIVRDIKEKLCYVALDFEQEMATAASSSSLEKSYELPDGQVITIGNERFRCPEALFQPSFLGMESCGIHETTFNSIMKCDVDIRKDLYANTVLSGGTTMYPGIADRMQKEITALAPSTMKIKIIAPPERKYSVWIGGSILASLSTFQQMWISKQEYDESGPSIVHRKCF

SEQ ID NO: 2 - protein, 568 aa, Homo sapiens
MVLGPEQKMSDDSVSGDHGESASLGNINPAYSNPSLSQSPGDSEEYFATYFNEKISIPEEEYSCFSFRKLWAFTGPGFLMSIAYLDPGNIESDLQSGAVAGFKLLWILLLATLVGLLLQRLAARLGVVTGLHLAEVCHRQYPKVPRVILWLMVELAIIGSDMQEVIGSAIAINLLSVGRIPLWGGVLITIADTFVFLFLDKYGLRKLEAFFGFLITIMALTFGYEYVTVKPSQSQVLKGMFVPSCSGCRTPQIEQAVGIVGAVIMPHNMYLHSALVKSRQVNRNNKQEVREANKYFFIESCIALFVSFIINVFVVSVFAEAFFGKTNEQVVEVCTNTSSPHAGLFPKDNSTLAVDIYKGGVVLGCYFGPAALYIWAVGILAAGQSSTMTGTYSGQFVMEGFLNLKWSRFARVVLTRSIAIIPTLLVAVFQDVEHLTGMNDFLNVLQSLQLPFALIPILTFTSLRPVMSDFANGLGWRIAGGILVLIICSINMYFVVVYVRDLGHVALYVVAAVVSVAYLGFVFYLGWQCLIALGMSFLDCGHTCHLGLTAQPELYLLNTMDADSLVSR

SEQ ID NO: 3 - protein, 509 aa, Homo sapiens
GKMFGQNSTLVIHKAIHTGEKPYKCNECGKAFNQQSHLSRHHRLHTGEKPYKCNDCGKAFIHQSSLARHHRLHTGEKSYKCEECDRVFSQKSNLERHKIIHTGEKPYKCNECHKTFSHRSSLPCHRRLHSGEKPYKCNECGKTFNVQSHLSRHHRLHTGEKPYKCKVCDKAFMCHSYLANHTRIHSGEKPYKCNECGKAHNHLIDSSIKPCMSSGQLFSHSSSDACSKNIHTGETFCKGNQCRKVCGHKQSLKQHQIHTQKKPDGCSECGGSFTQKSHLFAQQRIHSVGNLHECGKCGKAFMPQLKLSVYLTDHTGDIPCICKECGKVFIQRSELLTHQKTHTRKKPYKCHDCGKAFFQMLSLFRHQRTHSREKLYECSECGKGFSQNSTLIIHQKIHTGERQYACSECGKAFTQKSTLSLHQRIHSGFSKIHTGEKNCKLHHTKPCCGFSLRHCCFLHTGPCECKFRSLHHKPYKCCGKFLRHRHEKYCCKFSLHIHGEYCECGKASS

SEQ ID NO: 4 - protein, 606 aa, Homo sapiens
CPSQCSCSLHIMGDGSKARTVVCNDPDMTLPPASIPPDTSRLRLERTAIRRVPGEAFRPLGRLEQLWLPYNALSELNALMLRGLRRLRELRLPGNRLAAFPWAALRDAPKLRLLDLQANRLSAVPAEAARFLENLTFLDLSSNQLMRLPQELIVSWAHLETGIFPPGHHPRRVLGLQDNPWACDCRLYDLVHLLDGWAPNLAFIETELRCASPRSLAGVAFSQLELRKCQGPELHPGVASIRSLLGGTALLRCGATGVPGPEMSWRRANGRPLNGTVHQEVSSDGTSWTLLCPATCSCTKESIICVGSSWVPRIVPGDISSLSLVNGTFSEIKDRMFSHLPSLQLLLLNSNSFTIIRDDAFAGLFHLEYLFIEGNKIETISRNAFRGLRDLTHLSLANNHIKALPRDVFSDLDSLIELDLRGNKFECDCKAKWLYLWLKMTNSTVSDVLCIGPPEYQEKKLNDVTSFDYECTTTDFVVHQTLPYQSVSVDTFNSKNDVYVAIAQPSMENCMVLEWDHIEMNFRSYDNITGQSIVGCKAILIDDQVFVVVAQLFGGSHIYCPCSCPPDSLLFLLLLNGLLLGNARLLLNAPLLLDLNTYLDTVLSVV

(19) United States
(12) Patent Application Publication
(10) Pub. No.: US 2015/0242752 A1
(43) Pub. Date: Aug. 27, 2015

(54) APPROVAL PREDICTION APPARATUS, APPROVAL PREDICTION METHOD, AND COMPUTER PROGRAM PRODUCT

(71) Applicant: Japan Science and Technology Agency, Kawaguchi-shi, Saitama (JP)

(72) Inventors: Tiago Jose Da Silva Lopes, Tokyo (JP); Hiroaki Kitano, Tokyo (JP); Yoshihiro Kawaoka, Tokyo (JP)

(73) Assignee: Japan Science and Technology Agency, Kawaguchi-shi, Saitama (JP)

(21) Appl. No.: 14/431,415

(22) PCT Filed: Sep. 27, 2013
(86) PCT No.: PCT/JP2013/076248

§ 371 Date: Mar. 26, 2015

(30) Foreign Application Priority Data
Oct. 1, 2012 (JP) 2012-219730

(51) Int. Cl. G06N 5/04; G06N 99/00

(52) U.S. Cl. CPC G06N 5/04; G06N 99/005

(57) ABSTRACT

According to an aspect of the present invention, similarity centrality measures that are centrality measures of proteins that a protein similarity network includes are calculated, interaction centrality measures that are centrality measures of the proteins that the protein-protein interaction network includes are calculated, a rejection score that represents probability of a compound to be validated to be classified as a rejected drug is calculated using classifiers that use, as training data, the approval attributes of the respective drugs, the sum and average of the similarity centrality measures per target for each drug, and the sum and average of the interaction centrality measures per target for each drug, and the rejection score is output.

### TECHNICAL FIELD

The present invention relates to an approval prediction apparatus, an approval prediction method, and a computer program product.

### BACKGROUND ART

Conventional technologies for predicting off-targets and side effects of existing compounds have been disclosed.

As for the identification of protein functions according to Non Patent Literature 1, a technology for detecting off-targets of drugs by grouping proteins according to the similarities between their ligands has been disclosed where unexpected relations between drugs, such as methadone, emetine and loperamide, are found in that they antagonize receptors not previously reported in the literature.

As for the identification of drug targets according to Non Patent Literature 2, a technology has been disclosed where off-target effects are investigated using the side-effects caused by marketed drugs as a starting point and drugs are grouped according to their side effects to group the drugs having indications and structures, which makes it possible to determine additional protein targets for the drugs that were not known before.

As for the prediction of new molecular targets of known drugs according to Non Patent Literature 3, a technology has been disclosed where proteins are grouped according to the similarity of their ligands and off-target effects are investigated to find other targets in addition to the reported targets.

As for the prediction of drug target interaction networks according to Non Patent Literature 4, a technology has been disclosed where information on protein sequences and drug targets are correlated to newly create a resource referred to as “pharmacological space” and, using this resource, known additional targets for known drugs are revealed and the drug targets are classified into four classes of enzymes, ion channels, G-protein-coupled and nuclear receptors.

As for the large-scale prediction of drug activity according to Non Patent Literature 5, a technology has been disclosed where a drug target-adverse effect network that is used to predict and explain the side effects of marketed drugs is created and, from various unintended interaction between drugs and certain proteins, adverse effects that cannot be explained before can be discovered.

The drug induced liver injury prediction system according to Non Patent Literature 6 is a prediction system for identifying a compound with a high potential to cause liver injury, and a technology has been disclosed where a prediction target is limited to liver and a characteristic of a given type of compound to be likely to cause liver injury is predicted based on the investigations according to scientific literatures. The drug induced liver injury prediction system predicts some proteins and pathways having a potential to cause harmful effects to liver.

### CITATION LIST

### Non Patent Literature

Non Patent Literature 1: Keiser M J, Roth B L, Armbruster B N, Ernsberger P, Irwin J J, Shoichet B K. (2007) Relating protein pharmacology by ligand chemistry, Nature Biotechnology, 25, 197-206.
Non Patent Literature 2: Campillos M, Kuhn M, Gavin A C, Jensen L J, Bork P. (2008) Drug Target Identification Using Side-Effect Similarity, Science, 321, 263-266.
Non Patent Literature 3: Keiser M J, Setola V, Irwin J J, Laggner C, Abbas A I, Hufeisen S J, Jensen N H, Kuijer M B, Matos R C, Tran T B, Whaley R, Glennon R A, Hert J, Thomas K L, Edwards D D, Shoichet B K, Roth B L. (2009) Predicting new molecular targets for known drugs, Nature, 462, 175-181.
Non Patent Literature 4: Yamanishi Y, Araki M, Gutteridge A, Honda W, Kanehisa M (2008) Prediction of drug target interaction networks from the integration of chemical and genomic spaces, Bioinformatics, 24, i232-i240.
Non Patent Literature 5: Lounkine E, Keiser M J, Whitebread S, Mikhailov D, Hamon J, Jenkins J L, Lavan P, Weber E, Doak A K, Cote S, Shoichet B K, Urban L. (2012) Large-scale prediction and testing of drug activity on side-effect targets, Nature, 486, 361-367.
Non Patent Literature 6: Liu Z, Shi Q, Ding D, Kelly R, Fang H, et al. (2011) Translating Clinical Findings into Knowledge in Drug Safety Evaluation—Drug Induced Liver Injury Prediction System (DILIps). PLoS Comput Biol 7(12): e1002310.

### SUMMARY OF INVENTION

### Problem to be Solved by the Invention

The conventional drug target prediction technologies described in Non Patent Literature 1 to 6, however, have a problem in that they do not make it possible to quantify the probability of drug approval based on the properties of target proteins.

The present invention was made in view of the above-described problem, and an object of the present invention is to provide an approval prediction apparatus, an approval prediction method, and a computer program product that allow to quantify the probability of drug approval or rejection upon evaluation.

### Means for Solving Problem

In order to attain this object, an approval prediction apparatus according to one aspect of the present invention is an approval prediction apparatus comprising an output unit, a storage unit, and a control unit, wherein the storage unit includes a similarity network information storage unit that stores similarity network information on a protein similarity network that is constructed according to the similarity between proteins, a drug target storage unit that stores drug information containing approval attributes of drugs on approval or rejection and protein information on the proteins targeted by the drugs in association with each other, and an interaction network information storage unit that stores interaction network information on a protein-protein interaction network that is constructed based on interactions between the proteins, and the control unit includes a similarity centrality measure calculating unit that, based on the similarity network information stored in the similarity network information storage unit, calculates similarity centrality measures that are centrality measures containing the degree centrality, betweenness centrality, closeness centrality, and Burt's constraint of the proteins that the protein similarity network includes, an interaction centrality measure calculating unit that, based on the interaction network information stored in the interaction network information storage unit, calculates interaction centrality measures that are centrality measures containing the degree centrality, betweenness centrality, closeness centrality, and Burt's constraint of the proteins that the protein-protein interaction network includes, a rejection score calculating unit that calculates a rejection score that represents probability of a compound to be validated to be classified as a rejected drug, using classifiers that use, as training data, the approval attributes of the respective drugs stored in the drug target storage unit, the sum and average of the similarity centrality measures per target for each drug that are calculated by the similarity centrality measure calculating unit, and the sum and average of the interaction centrality measures per target for each drug that are calculated by the interaction centrality measure calculating unit, and a rejection score outputting unit that outputs, via the output unit, the rejection score that is calculated by the rejection score calculating unit.

An approval prediction apparatus according to another aspect of the present invention is an approval prediction apparatus comprising an output unit, a storage unit, and a control unit, wherein the storage unit includes a similarity network information storage unit that stores similarity network information on a protein similarity network that includes proteins having similarity, and a drug target storage unit that stores drug information containing approval attributes of drugs on approval or rejection and protein information on the proteins targeted by the drugs in association with each other, and the control unit includes a similarity centrality measure calculating unit that, based on the similarity network information stored in the similarity network information storage unit, calculates similarity centrality measures that are centrality measures containing the degree centrality, betweenness centrality, closeness centrality, and Burt's constraint of the proteins that the protein similarity network includes, an approval determining unit that, based on the approval attributes of the drugs targeting the proteins according to the protein information stored in the drug target storage unit, which are the proteins that the protein similarity network includes, obtains a determination result representing whether the proteins to be validated, which are proteins that the similarity network includes, are within a range of targets of approved drugs or a range of targets of rejected drugs, using the similarity centrality measures of the proteins to be validated that are calculated by the similarity centrality measure calculating unit, and a determination result outputting unit that outputs, via the output unit, the determination result that is obtained by the approval determining unit.

The approval prediction apparatus according to still another aspect of the present invention is the approval prediction apparatus, wherein the storage unit further includes a protein sequence information storage unit that stores sequence information on amino acid sequences of the proteins, and the control unit further includes a similarity network information storing unit that, when the similarity is detected between the proteins using a signature-based algorithm and based on the sequence information stored in the protein sequence information storage unit, creates the protein similarity network including the proteins between which the similarity is detected and stores the similarity network information on the protein similarity network in the similarity network information storage unit.

The approval prediction apparatus according to still another aspect of the present invention is the approval prediction apparatus, wherein, based on the approval attributes of the drugs targeting the proteins according to the protein information stored in the drug target storage unit, which are the proteins that the protein similarity network includes, the approval determining unit generates a determination result representing that the proteins to be validated are within the range of targets of rejected drugs when the degree centrality contained in the similarity centrality measures of the proteins to be validated that are calculated by the similarity centrality measure calculating unit is high, the closeness centrality is low, and the Burt's constraint is extremely low.

An approval prediction method according to still another aspect of the present invention is an approval prediction method executed by an approval prediction apparatus including an output unit, a storage unit, and a control unit, wherein the storage unit includes a similarity network information storage unit that stores similarity network information on a protein similarity network that is constructed according to the similarity between proteins, a drug target storage unit that stores drug information containing approval attributes of drugs on approval or rejection and protein information on the proteins targeted by the drugs in association with each other, and an interaction network information storage unit that stores interaction network information on a protein-protein interaction network that is constructed based on interactions between the proteins, the method executed by the control unit comprising a similarity centrality measure calculating step of, based on the similarity network information stored in the similarity network information storage unit, calculating similarity centrality measures that are centrality measures containing the degree centrality, betweenness centrality, closeness centrality, and Burt's constraint of the proteins that the protein similarity network includes, an interaction centrality measure calculating step of, based on the interaction network information stored in the interaction network information storage unit, calculating interaction centrality measures that are centrality measures containing the degree centrality, betweenness centrality, closeness centrality, and Burt's constraint of the proteins that the protein-protein interaction network includes, a rejection score calculating step of calculating a rejection score that represents probability of a compound to be validated to be classified as a rejected drug, using classifiers that use, as training data, the approval attributes of the respective drugs stored in the drug target storage unit, the sum and average of the similarity centrality measures per target for each drug that are calculated at the similarity centrality measure calculating step, and the sum and average of the interaction centrality measures per target for each drug that are calculated at the interaction centrality measure calculating step, and a rejection score outputting step of outputting, via the output unit, the rejection score that is calculated at the rejection score calculating step.

An approval prediction method according to still another aspect of the present invention is an approval prediction method executed by an approval prediction apparatus including an output unit, a storage unit, and a control unit, wherein the storage unit includes a similarity network information storage unit that stores similarity network information on a protein similarity network that includes proteins having similarity, and a drug target storage unit that stores drug information containing approval attributes of drugs on approval or rejection and protein information on the proteins targeted by the drugs in association with each other, and the method executed by the control unit includes a similarity centrality measure calculating step of, based on the similarity network information stored in the similarity network information storage unit, calculating similarity centrality measures that are centrality measures containing the degree centrality, betweenness centrality, closeness centrality, and Burt's constraint of the proteins that the protein similarity network includes, an approval determining step of, based on the approval attributes of the drugs targeting the proteins according to the protein information stored in the drug target storage unit, which are the proteins that the protein similarity network includes, obtaining a determination result representing whether the proteins to be validated, which are proteins that the similarity network includes, are within a range of targets of approved drugs or a range of targets of rejected drugs, using the similarity centrality measures of the proteins to be validated that are calculated at the similarity centrality measure calculating step, and a determination result outputting step of outputting, via the output unit, the determination result that is obtained at the approval determining step.

A computer program product according to still another aspect of the present invention is a computer program product having a non-transitory tangible computer readable medium including programmed instructions for causing, when executed by an approval prediction apparatus including an output unit, a storage unit, and a control unit, wherein the storage unit includes a similarity network information storage unit that stores similarity network information on a protein similarity network that is constructed according to the similarity between proteins, a drug target storage unit that stores drug information containing approval attributes of drugs on approval or rejection and protein information on the proteins targeted by the drugs in association with each other, and an interaction network information storage unit that stores interaction network information on a protein-protein interaction network that is constructed based on interactions between the proteins, and the approval prediction apparatus to perform an approval prediction method comprising a similarity centrality measure calculating step of, based on the similarity network information stored in the similarity network information storage unit, calculating similarity centrality measures that are centrality measures containing the degree centrality, betweenness centrality, closeness centrality, and Burt's constraint of the proteins that the protein similarity network includes, an interaction centrality measure calculating step of, based on the interaction network information stored in the interaction network information storage unit, calculating interaction centrality measures that are centrality measures containing the degree centrality, betweenness centrality, closeness centrality, and Burt's constraint of the proteins that the protein-protein interaction network includes, a rejection score calculating step of calculating a rejection score that represents probability of a compound to be validated to be classified as a rejected drug, using classifiers that use, as training data, the approval attributes of the respective drugs stored in the drug target storage unit, the sum and average of the similarity centrality measures per target for each drug that are calculated at the similarity centrality measure calculating step, and the sum and average of the interaction centrality measures per target for each drug that are calculated at the interaction centrality measure calculating step, and a rejection score outputting step of outputting, via the output unit, the rejection score that is calculated at the rejection score calculating step.

A computer program product according to still another aspect of the present invention is a computer program product having a non-transitory tangible computer readable medium including programmed instructions for causing, when executed by an approval prediction apparatus including an output unit, a storage unit, and a control unit, wherein the storage unit includes a similarity network information storage unit that stores similarity network information on a protein similarity network that includes proteins having similarity, and a drug target storage unit that stores drug information containing approval attributes of drugs on approval or rejection and protein information on the proteins targeted by the drugs in association with each other, and the approval prediction apparatus to perform an approval prediction method comprising a similarity centrality measure calculating step of, based on the similarity network information stored in the similarity network information storage unit, calculating similarity centrality measures that are centrality measures containing the degree centrality, betweenness centrality, closeness centrality, and Burt's constraint of the proteins that the protein similarity network includes, an approval determining step of, based on the approval attributes of the drugs targeting the proteins according to the protein information stored in the drug target storage unit, which are the proteins that the protein similarity network includes, obtaining a determination result representing whether the proteins to be validated, which are proteins that the similarity network includes, are within a range of targets of approved drugs or a range of targets of rejected drugs, using the similarity centrality measures of the proteins to be validated that are calculated at the similarity centrality measure calculating step, and a determination result outputting step of outputting, via the output unit, the determination result that is obtained at the approval determining step.

### Effect of the Invention

According to one aspect of the present invention, similarity centrality measures that are centrality measures containing the degree centrality, betweenness centrality, closeness centrality, and Burt's constraint of proteins that a protein similarity network includes are calculated, interaction centrality measures that are centrality measures containing the degree centrality, betweenness centrality, closeness centrality, and Burt's constraint of the proteins that the protein-protein interaction network includes are calculated, a rejection score that represents probability of a compound to be validated to be classified as a rejected drug is calculated using classifiers that use, as training data, the approval attributes of the respective drugs, the sum and average of the calculated similarity centrality measures per target for each drug, and the sum and average of the calculated interaction centrality measures per target for each drug, and the calculated rejection score is output via the output unit. The present invention thus provides an advantage that taking the properties of all proteins into account as targets for a compound allows its applications for prediction of approval or rejection of several target compounds. The present invention further provides an advantage that scoring the probability of candidate compounds to cause undesirable side-effects using machine learning classifiers allows its use at early stages of drug development and helps prioritizing compounds with higher probability of approval.

According to another aspect of the present invention, similarity centrality measures that are centrality measures containing the degree centrality, betweenness centrality, closeness centrality, and Burt's constraint of the proteins that the protein similarity network includes are calculated, based on the approval attributes of the drugs targeting the proteins that the protein similarity network includes, a determination result representing whether the proteins to be validated, which are proteins that the similarity network includes, are within a range of targets of approved drugs or a range of targets of rejected drugs, is obtained using the calculated similarity centrality measures of the proteins to be validated, and the obtained determination result is output via the output unit. Accordingly, the present invention provides an advantage that it is possible to specify the characteristics of individual proteins and determine whether there is probability that harmful effects would be produced. The invention further provides an advantage that it can be used for technologies for siRNA based therapies, evaluating individual targets, such as single-target compounds (aka ‘magic bullets’) and modulating the activity of single specific proteins.

According to still another aspect of the present invention, the protein similarity network including the proteins between which the similarity is detected is created when the similarity is detected between the proteins using a signature-based algorithm, and the similarity network information on the protein similarity network is stored. Accordingly, the invention provides an advantage that it is possible to provide network data with more considerable similarity than that of the conventional publically-available network data.

According to still another aspect of the present invention, based on the approval attributes of the drugs targeting the proteins that the protein similarity network includes, a determination result representing that the proteins to be validated are within the range of targets of rejected drugs is generated when the degree centrality contained in the calculated similarity centrality measures of the proteins to be validated is high, the closeness centrality is low, and the Burt's constraint is extremely low. Accordingly, the invention provides an advantage that it is possible to accurately identify proteins prone to unspecific binding and side-effects.

### BRIEF DESCRIPTION OF DRAWINGS

FIG. 1 is a flowchart of the basic idea of an embodiment.

FIG. 2 is a flowchart of the basic idea of the embodiment.

FIG. 3 is a block diagram of an exemplary configuration of an approval prediction apparatus according to the embodiment.

FIG. 4 is a flowchart of an exemplary processing performed by the approval prediction apparatus according to the embodiment.

FIG. 5 is a diagram of exemplary sequence information according to the embodiment.

FIG. 6 is a diagram of exemplary similarity network information according to the embodiment.

FIG. 7 is a diagram of exemplary Burt's constraint according to the embodiment.

FIG. 8 is a table of exemplary centrality measures of proteins according to the embodiment.

FIG. 9 is a table of exemplary information that is stored in a drug target database according to the embodiment.

FIG. 10 is a diagram of exemplary centrality measures of an approved and rejected drug target according to the embodiment.

FIG. 11 is a table of exemplary interaction network information according to the embodiment.

FIG. 12 is a graph of exemplary improvement of the performance of classifiers according to the embodiment.

FIG. 13 is a graph of exemplary accuracy of classification by classifiers according to the embodiment.

FIG. 14 is a table of exemplary classifiers according to the embodiment.

FIG. 15 is a table of exemplary output information according to the embodiment.

### MODE(S) FOR CARRYING OUT THE INVENTION

An embodiment of an approval prediction apparatus, an approval prediction method, and a computer program product according to the present invention will be explained in detail below according to the drawings. The embodiment does not limit the invention.

### Overview of Embodiment of Invention

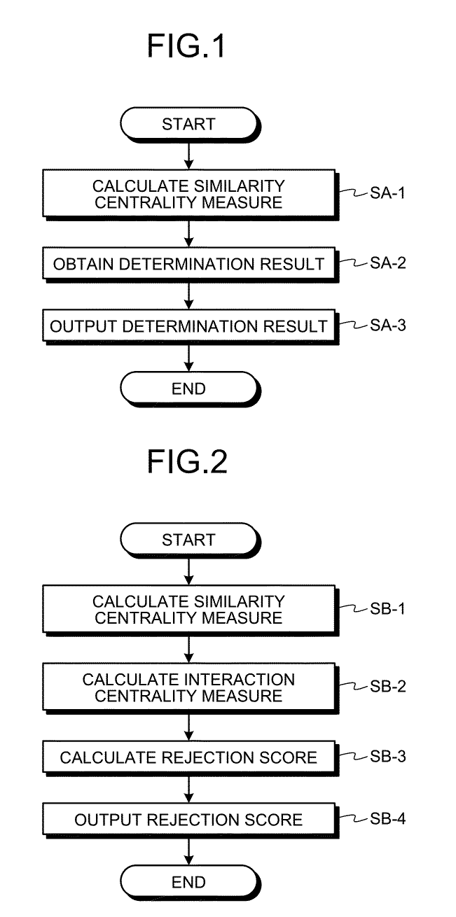

An overview of the embodiment of the invention will be explained with reference to FIGS. 1 and 2 and then a configuration and processing according to the embodiment will be explained in detail below.

Overview (1)

With reference to FIG. 1, an exemplary overview of the embodiment of the invention will be explained. FIG. 1 is a flowchart of the basic idea of the embodiment. Schematically, the embodiment has the following basic features.

Specifically, as shown in FIG. 1, the control unit of the approval prediction apparatus according to the embodiment calculates similarity centrality measures that are centrality measures containing the degree centrality, betweenness centrality, closeness centrality, and Burt's constraint of proteins that a protein similarity network includes (step SA-1).

Based on the approval attributes of drugs targeting proteins that the protein similarity network includes, a control unit of the approval prediction apparatus obtains a determination result representing whether the proteins to be validated, which are proteins that the similarity network includes, are within the range of targets of approved drugs or the range of targets of rejected drugs, using the similarity centrality measures of the proteins to be validated that are calculated at step SA-1 (step SA-2).

The control unit of the approval prediction apparatus outputs the determination result obtained at step SA-2 (step SA-3) via an output unit and ends the processing.

This is the explanation of Overview (1).

Overview (2)

With reference to FIG. 2, an exemplary overview of the embodiment of the invention will be explained. FIG. 2 is a flowchart of the basic idea of the embodiment.

As shown in FIG. 2, the control unit of the approval prediction apparatus according to the embodiment calculates similarity centrality measures that are centrality measures containing the degree centrality, betweenness centrality, closeness centrality, and Burt's constraint of proteins that a protein similarity network includes (step SB-1).

The control unit of the approval prediction apparatus according to the embodiment then calculates interaction centrality measures that are centrality measures containing the degree centrality, betweenness centrality, closeness centrality, and Burt's constraint of proteins that a protein-protein interaction network includes (step SB-2).

The control unit of the approval prediction apparatus calculates a rejection score that represents probability that a compound to be validated is classified as a rejected drug, using classifiers that use, as training data, the approval attribute of each drug, the sum and average of the similarity centrality measures per target for each drug that are calculated at step SB-1, and the sum and average of the interaction centrality measures per target for each drug that are calculated at step SB-2 (step SB-3).

The control unit of the approval prediction apparatus outputs the rejection score that is calculated at step SB-3 (step SB-4) via the output unit and ends the processing.

This is the explanation of the overview of the embodiment.

Configuration of Approval Prediction Apparatus 100

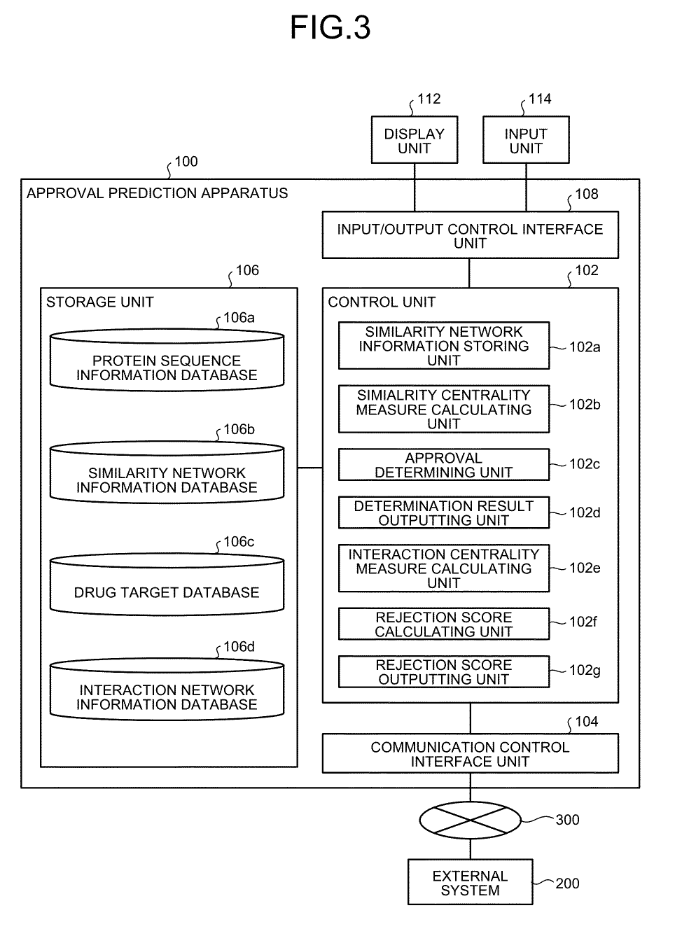

Details of the configuration of the approval prediction apparatus 100 according to the embodiment will be explained below with reference to FIG. 3. FIG. 3 is a block diagram of an exemplary configuration of the approval prediction apparatus 100 according to the embodiment and schematically illustrates only components relevant to the invention. In the approval prediction apparatus 100 according to the embodiment, all components are provided in a single enclosure, and one that independently performs processing (stand-alone) will be explained as the approval prediction apparatus 100; however, in addition to this example, it may be one (e.g., cloud computing) in which components are provided respectively in independent enclosures and are connected via a network 300, or the like, to configure an apparatus as a single concept.

In FIG. 3, an external system 200 and the approval prediction apparatus 100 are interconnected via the network 300. The external system 200 may have a function of providing any one or both of an external database relating to any one, some, or all of protein sequence information, drug information, drug target information, and protein-protein interaction information, and a website for implementing a user interface, or the like.

The external system 200 may be configured as a web server or as an ASP server. The hardware configuration of the external system 200 may include an information processing device, such as a marketed work station or a personal computer, and its peripheral devices. Each function of the external system 200 may be implemented by a CPU, a disk device, a memory device, an input device, an output device, and a communication control device of the hardware configuration of the external system 200 and a computer program for controlling them.

The network 300 has a function of interconnecting the approval prediction apparatus 100 and the external system 200. The network 300 is, for example, the Internet.

The approval prediction apparatus 100 schematically includes a control unit 102, a communication control interface unit 104, a storage unit 106, and an input/output control interface unit 108. The approval prediction apparatus 100 may further include an output unit, including the display unit 112, and an input unit 114. The output unit may further include an audio output unit and a print output unit. The control unit 102 is a CPU, or the like, that generally controls the whole approval prediction apparatus 100. The communication control interface unit 104 is an interface that is connected to a communication device (not shown), such as a router, connected to a communication line, or the like, and the input/output control interface unit 108 is an interface that is connected to the output unit and the input unit 114. The storage unit 106 is a device that stores various databases and tables. The units of the approval prediction apparatus 100 are communicably connected to one another via arbitrary communication paths. Furthermore, the approval prediction apparatus 100 is communicably connected to the network 300 via a communication device, such as a router, or a wired or wireless communication line, such as a dedicated line.

The various databases and tables stored in the storage unit 106 (a protein sequence information database 106a, a similarity network information database 106b, a drug target database 106c, and an interaction network information database 106d) are storage units, such as a fixed disk device. For example, the storage unit 106 stores various programs used for various types of processing, tables, files, databases, and webpages.

From among the components of the storage unit 106, the protein sequence information database 106a is a protein sequence information storage unit that stores sequence information on protein amino acid sequences. The amino acid sequences may be human protein amino acid sequences. The sequence information may be in FASTA format. The sequence information is previously stored in the protein sequence information database 106a. The control unit 102 of the approval prediction apparatus 100 may, periodically and/or according to the processing performed by the control unit 102, download the latest data via the network 300 from the external system 200 (e.g., an NCBI or an UNIPROT) and update the sequence information stored in the protein sequence information database 106a.

The similarity network information database 106b is a similarity network information storage unit that stores protein similarity network information on a protein similarity network (PSIN) including proteins having similarity.

The drug target database 106c is a drug target storage unit that stores drug information including approval attributes of drugs on approval or rejection and protein quality information on proteins targeted by the drugs in association with each other. The rejected drugs may be drugs that are, according to the embodiment, withdrawn or illicit drugs in drug approval that are regarded as a group of problematic drugs. In other words, problematic drugs may be drugs that have to be withdrawn from the markets because of their harmful effects or illegal drugs (e.g., stimulants or hallucinogens) that are socially prohibited and that have to be distinguished from approved drugs. The drug information and the protein information on drug approval are stored beforehand in the drug target database 106c and the control unit 102 of the approval prediction apparatus 100 periodically, and/or according to the processing performed by the control unit 102, downloads the latest data from the external system 200 (e.g., Drugbank (http://www.drugbank.ca/)) via the network 300 and updates the drug information and the protein information on drug approval that are stored in the drug target database 106c.

The interaction network information database 106d is an interaction network information storage unit that stores interaction network information on a protein-protein interaction network (PPI) constructed according to the interactions between proteins. The interaction network information is stored beforehand in the interaction network information database 106d, and the control unit 102 of the approval prediction apparatus 100 periodically, and/or according to the processing performed by the control unit 102, downloads the latest data from the external system 200 (e.g., HIPPIE (http://cbdm.mdc-berlin.de/tools/hippie/)) via the network 300 and updates the interaction network information that is stored in the interaction network information database 106d.

The communication control interface unit 104 performs communication control between the approval prediction apparatus 100 and the network 300 (or a communication device such as a router). In other words, the communication control interface unit 104 has a function of communicating data with the external system 200 and other terminals via communication lines.

The input/output control interface unit 108 controls the output unit (display unit 112) and the input unit 114.

The display unit 112 may be a display unit (such as a display, monitor, or a touch panel configured of liquid crystals or organic EL) that displays a display screen of an application or the like. The input unit 114 may be, for example, a key input unit, a touch panel, a control pad (e.g., a touch pad or gamepad), a mouse, a keyboard, or a microphone. It may be, as an audio output unit, for example, a speaker. It may be, as a print output unit, for example, a printer.

The control unit 102 in FIG. 3 has an internal memory for storing control programs of an operating system (OS), etc., programs that define various process procedures, and necessary data. The control unit 102 performs information processing for performing various processes according to the programs, etc. The control unit 102 includes, as functional concepts, a similarity network information storing unit 102a, a similarity centrality measure calculating unit 102b, an approval determining unit 102c, a determination result outputting unit 102d, an interaction centrality measure calculating unit 102e, a rejection score calculating unit 102f, and a rejection score outputting unit 102g.

The similarity network information storing unit 102a is a similarity network information storing unit that, when similarity is detected between proteins using a signature-based algorithm and based on the sequence information stored in the protein sequence information database 106a, creates a protein similarity network (PSIN) including the proteins between which the similarity is detected and stores the similarity network information on the protein similarity network in the similarity network information database 106b.

The similarity centrality measure calculating unit 102b is a similarity centrality measure calculating unit that calculates, based on the similarity network information stored in the similarity network information database 106b, similarity centrality measures that are centrality measures containing the degree centrality, betweenness centrality, closeness centrality, and Burt's constraint of the proteins that the protein similarity network includes. The degree centrality is an index representing how much the node is directly connected to other nodes (how many direct connections to other nodes the node has) in the network. The betweenness centrality measures the centrality of the protein network by counting the number of shortest paths that have to be passed to connect to other nodes in the network. The closeness centrality measures how many steps are necessary to reach every other node in the network. The Burt's constraint is an index proposed in a sociological context to study the positions and advantages of individuals within a group.

The approval determining unit 102c is an approval determining unit that, based on the approval attributes of the drugs targeting the proteins according to the protein information stored in the drug target database 106c, which are the proteins that the protein similarity network includes, obtains a determination result representing whether the proteins to be validated that the protein similarity network includes are within the range of targets of approved drugs or the range of targets of rejected drugs, using the centrality measures of the proteins to be validated that are calculated by the similarity centrality measure calculating unit 102b. The approval determining unit 102c may, based on the approval attributes of the drugs targeting the proteins according to the protein information stored in the drug target database 106c, which are the proteins that the protein similarity network includes, generate a determination result representing that the proteins to be validated are within the range of targets of rejected drugs when the degree centrality contained in the similarity centrality measures of the proteins to be validated that are calculated by the similarity centrality measure calculating unit 102b is high, the closeness centrality is low, and the Burt's constraint is extremely low. The proteins to be validated may be according to the protein information that is input by the user via the input unit 114.

The determination result outputting unit 102d is a determination result outputting unit that outputs the determination result obtained by the approval determining unit 102c via the output unit. The determination result outputting unit 102d may display the determination result on the display unit 112. The determination result outputting unit 102d may output the determination result via a print output unit.

The interaction centrality measure calculating unit 102e is an interaction centrality measure calculating unit that calculates, based on the interaction network information that is stored in the interaction network information database 106d, interaction centrality measures that are centrality measures containing the degree centrality, betweenness centrality, closeness centrality, and Burt's constraint of the proteins that the protein-protein interaction network includes.

The rejection score calculating unit 102f is a rejection score calculating unit that calculates a rejection score that represents probability that a compound to be validated is classified as a rejected drug, using classifiers that use, as training data, the approval attribute of each drug stored in the drug target database 106c, the sum and average of the similarity centrality measures per target for each drug that are calculated by the similarity centrality measure calculating unit 102b, and the sum and average of the interaction centrality measures per target for each drug that are calculated by the interaction centrality measure calculating unit 102e. The compound (drug) to be validated may be based on the compound information that is input by the user via the input unit 114.

The rejection score outputting unit 102g is a rejection score outputting unit that outputs the rejection score, which is calculated by the rejection score calculating unit 102f, via the output unit. The rejection score outputting unit 102g may display the rejection score on the display unit 112. The rejection score outputting unit 102g may output the rejection score via a print output unit.

The explanation of the exemplary configuration of the approval prediction apparatus 100 according to the embodiment configured as descried above ends here.

Processing Performed by Approval Prediction Apparatus 100

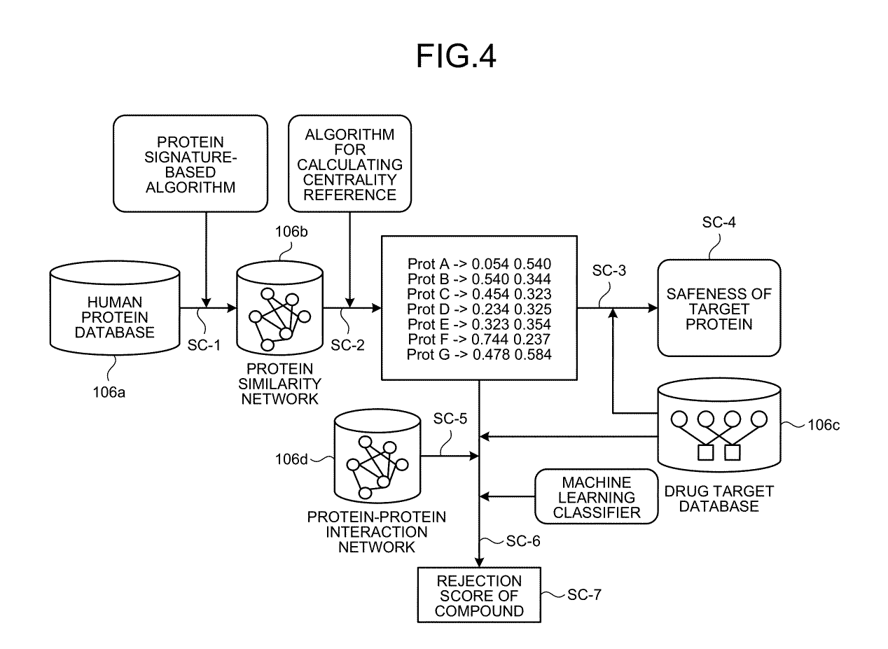

Details of the processing performed by the approval prediction apparatus 100 according to the embodiment configured as described above will be explained below with reference to FIGS. 4 to 15. FIG. 4 is a flowchart of exemplary processing performed by the approval prediction apparatus 100 according to the embodiment.

As shown in FIG. 4, when similarity is detected between proteins with a protein signature-based algorithm for finding similarity between protein homologs and based on the sequence information stored in the human protein database (protein sequence information database) 106a, the similarity network information storing unit 102a creates a protein similarity network (PSIN) including the proteins between which the similarity is detected and stores the similarity network information on the protein similarity network in the similarity network information database 106b (step SC-1). When the PSI-BLAST tool (Schaffer, et al., 2001) to query and compare each of the 22,000 human proteins to the NCBI human protein database is used in order to find similar proteins, distinct from previous studies (Atkinson, et al., 2009; Camoglu, et al., 2006; Rattei, et al., 2010; Valavanis, et al., 2010; Weston, et al., 2004; Zhang and Grigorov, 2006), the results representing that interaction (meaning that when protein A is queried and protein B is identified to be similar, protein B is queried and protein A is identified to be similar) are obtained. According to this result, the similarity network information storing unit 102a creates a new protein similarity network (PSIN) using graph theory representation. In the protein similarity network (PSIN), the nodes represent proteins and two nodes are connected by an edge only if the nodes share considerable protein sequence similarity and also, bidirectional hits (i.e., protein A is identified to be similar to protein B and vice-versa) are verified. Accordingly, the similarity network information storing unit 102a creates a protein similarity network (PSIN) containing 19,721 nodes and 776,598 edges.

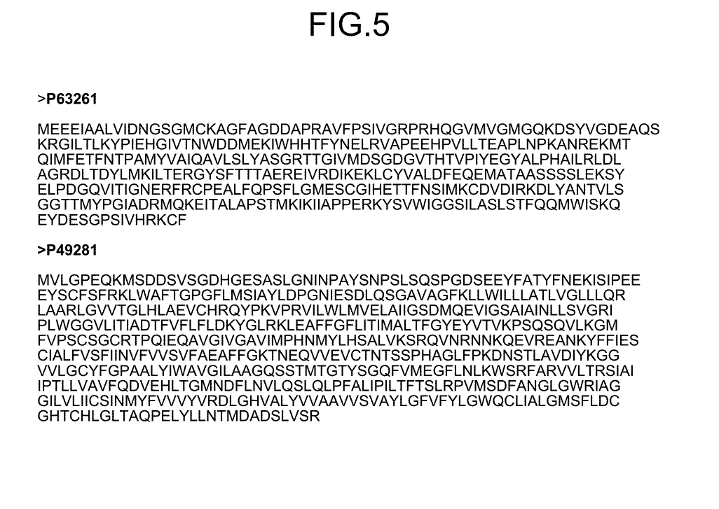

With reference to FIG. 5, exemplary sequence information according to the embodiment will be explained here. FIG. 5 is a diagram of the exemplary sequence information according to the embodiment.

As shown in FIG. 5, the sequence information stored in the protein sequence information database 106a may be protein sequence information on human proteins in FASTA format, such as P63261 and P49281.

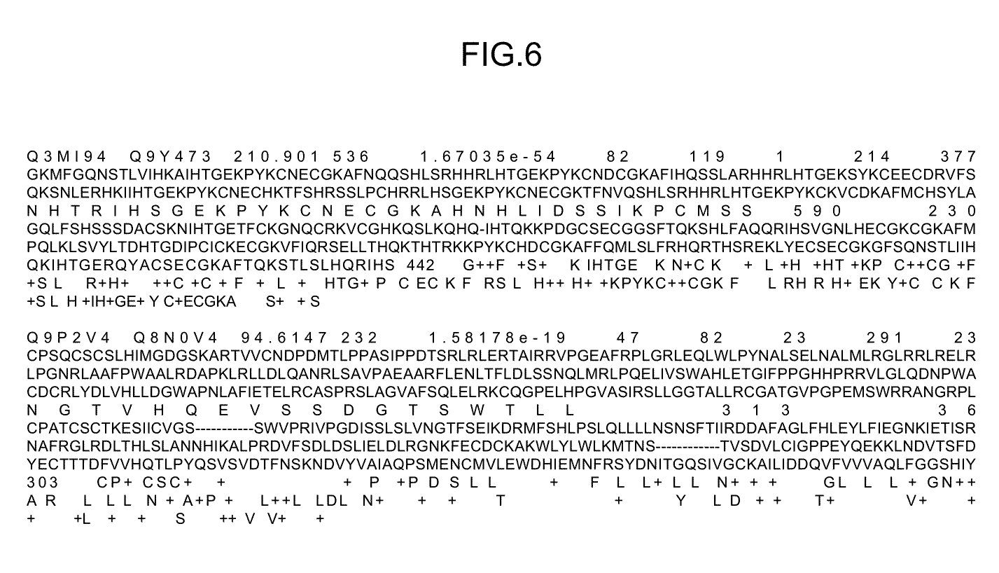

With reference to FIG. 6, the exemplary similarity network information according to the embodiment will be explained. FIG. 6 is a diagram of the exemplary similarity network information according to the embodiment.

As shown in FIG. 6, the similarity network information according to the embodiment may contain the names of proteins, the names of proteins similar to the protein (neighbours), the sequence scores, and the sequence information on the region where two proteins are similar. FIG. 6 exemplarily shows the similarity network information on the similarity between Q3M194 and Q9Y473 and the similarity network information on Q9P2V4 and Q8N0V4.

The following refers back to FIG. 4. Based on the similarity network information stored in the similarity network information database 106b and by using the algorithm for calculating a centrality reference, the similarity centrality measure calculating unit 102b calculates the degree centrality, betweenness centrality, closeness centrality and Burt's constraint of proteins that the protein similarity network (PSIN) includes (step SC-2).

The centrality measures of the proteins that the PSIN includes according to the embodiment will be explained here. The similarity centrality measure calculating unit 102b calculates the degree centrality that is an index representing how much the node is directly connected to nodes in the PSIN, ranging from 1 (the least connected) to 441 (the most connected) in the PSIN.

The similarity centrality measure calculating unit 102b calculates the betweenness centrality B(v) using the following Expression (1) formed of Sᵢⱼ denoting the number of shortest paths between a node i and a node j, and Sᵢⱼ(v) denoting the fraction of shortest paths passing through a node v.

$$\begin{matrix}Expression 1 & \\ B ( v ) = \sum \frac{{s}_{ij} ( v )}{{s}_{ij}} , \\ with i \neq j , v \neq i \\ and \\ v \neq j & ( 1 )\end{matrix}$$

The similarity centrality measure calculating unit 102b calculates the closeness centrality C(v) using the following Expression (2) formed of d(v,i) denoting the distance represented at the step between a node v and the node i.

$$\begin{matrix}Expression 2 & \\ C ( v ) = \frac{1}{\sum d ( v , i )} , \\ with \\ i \neq v & ( 2 )\end{matrix}$$

The similarity centrality measure calculating unit 102b calculates the Burt's constraint C(i) using the following Expression (3) formed of p_{iq}p_{qj} denoting a product of the proportional strength of the node j's relationship with the node i and the proportional strength of the node j's relationship with the node q.

$$\begin{matrix}Expression 3 & \\ C ( i ) = {\sum }_{j} {( {p}_{ij} + {\sum }_{q} {p}_{iq} {p}_{qj} )}^{2} , \\ with \\ q \neq i , j , \\ and \\ j \neq i & ( 3 )\end{matrix}$$

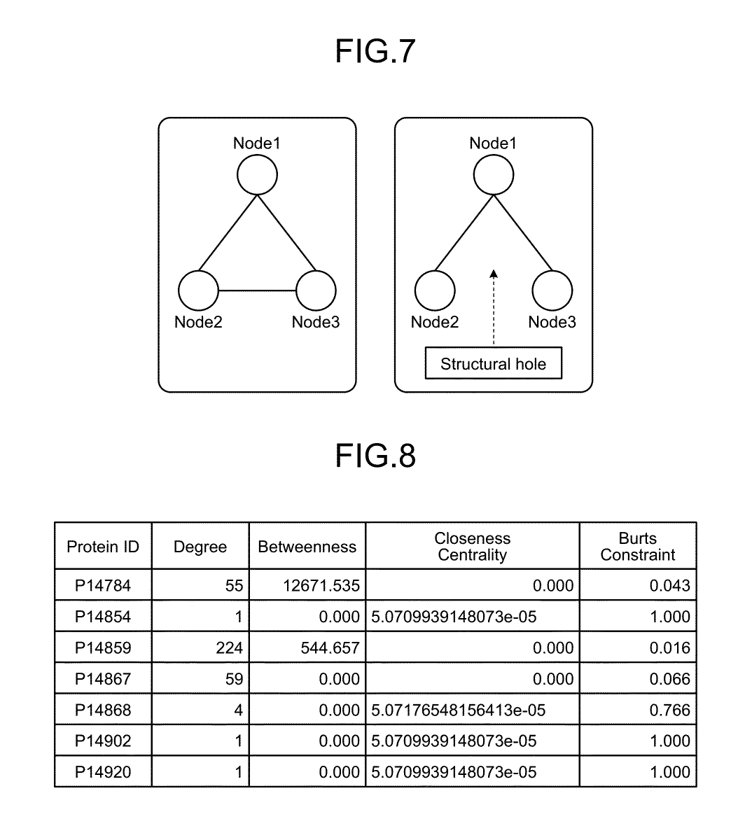

With reference to FIG. 7, the Burt's constraint according to the embodiment will be explained. FIG. 7 is a diagram of the exemplary Burt's constraint according to the embodiment.

The Burt's constraint is a method proposed in a sociological context to study the positions and advantages of individuals within a group. If the nodes are individuals in FIG. 7, all nodes have alternative connections and thus are able to negotiate or bargain with others according to the left diagram in FIG. 7. On the other hand, if there is a structural hole as shown in the right diagram in FIG. 7, Node 1 is in a better position for negotiation, because Node 2 and Node 3 are not able to be aware of each other's presence. The embodiment applies it to a similar context of nodes that are proteins so that proteins (nodes) with small Burt's constraint are generally those with several domains, located between different protein families, and proteins (nodes) with large Burt's constraint represent a few neighbors and sequence similarity.

With reference to FIG. 8, exemplary centrality measures of proteins according to the embodiment will be explained. FIG. 8 is a table of the exemplary centrality measures of proteins according to the embodiment.

As shown in FIG. 8, the similarity centrality measure calculating unit 102b may calculate, as centrality measures, the degree centrality, betweenness centrality, closeness centrality, and Burt's constraint of proteins (P14784, P14854, P14859, P14867, P14868, P14902, and P14920) that the PSIN includes and output a list of the centrality measures.

The following refers back to FIG. 4. Based on the approval attributes of drugs targeting the proteins according to the protein information stored in the drug target database 106c, which are proteins that the protein similarity network includes, the approval determining unit 102c obtains a determination result representing whether proteins to be validated that the protein similarity network includes are within the range of targets of approved drugs or the range of targets of rejected drugs (safeness of targeted proteins), using the degree centrality, betweenness centrality, closeness centrality, and Burt's constraint of the proteins to be validated that are calculated by the similarity centrality measure calculating unit 102b at step SC-2 (step SC-3). In other words, the approval determining unit 102c may require the centrality measures of the proteins that the protein similarity network includes and the list stored in the drug target database 106c and determine the ranges of values assuming targets of approved drugs and targets of rejected (withdrawn and illicit) drugs. At this step, only individual proteins, not the complete set of proteins that can be targeted by a compound, are considered. The motivation to determine the characteristics of individual drug targets is that single-target compounds (magic bullets) and siRNA based therapies are designed to inhibit only one target, and hence, it is essential to select the targets on the assumption that therapeutic inhibition of targets is safe.

The approval determining unit 102c may, based on the approval attributes of the drugs targeting the proteins according to the protein information stored in the drug target database 106c, which are proteins that the protein similarity network includes, generate a determination result representing that the proteins to be validated are within the range of targets of rejected drugs when the degree centrality contained in the similarity centrality measures of the proteins to be validated, which are the similarity centrality measures calculated by the similarity centrality measure calculating unit 102b at step SC-2, is high, the closeness centrality is low, and the Burt's constraint is extremely low.

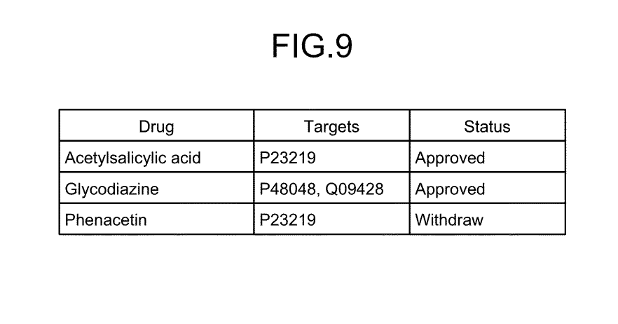

With reference to FIG. 9, exemplary information stored in the drug target database 106c according to the embodiment will be described. FIG. 9 is a diagram of the exemplary information stored in the drug target database 106c according to the embodiment.

As shown in FIG. 9, the information stored in the drug target database 106c according to the embodiment may contain the names of drugs (drug), names of proteins targeted by the drugs (targets), and approval attributes (status) on approval or rejection of the drugs (by the Japanese Ministry of Health, Labour and Welfare, the US FDA, or the like).

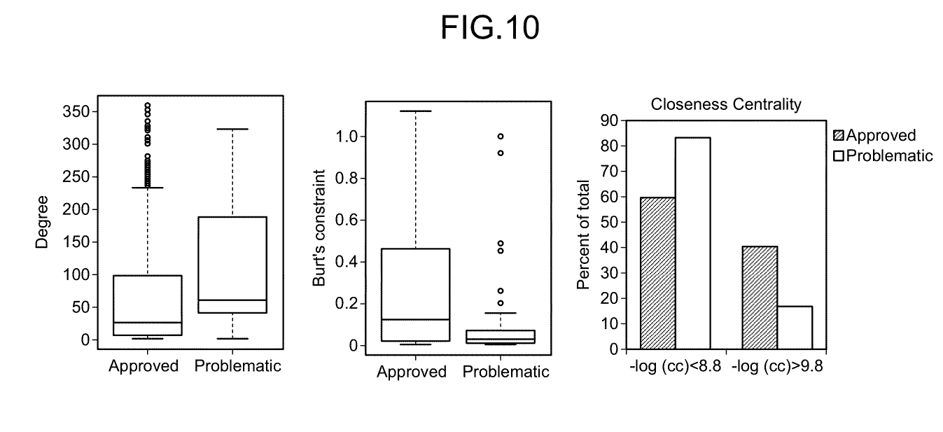

With reference to FIG. 10, exemplary centrality measures of approved or rejected targets according to the embodiment will be explained. FIG. 10 is a diagram of centrality measures of targets of approved and rejected drugs according to the embodiment.

As shown in FIG. 10, proteins targeted by rejected (problematic) drugs may show high degree centrality, significantly lower Burt's constraint, and lower closeness centrality in negative log scale. As shown in FIG. 10, while the targets of approved drugs have structures less shared among many other proteins (low-degree), targets of rejected drugs have structures much shared among several proteins, hence, having features of being prone to unspecific binding and side-effects.

The following refers back to FIG. 4. The determination result outputting unit 102d displays the safeness of the targeted proteins, which is obtained by the approval determining unit 102c, on the display unit 112 (step SC-4). The determination result outputting unit 102d may output the determination result via a print output unit. The determination result outputting unit 102d may output a list that users can query to verify whether the proteins of the user's interest are within the range of safe drug targets or the range of unsafe drug targets.

On the other hand, based on the interaction network information stored in the interaction network information database 106d, the interaction centrality measure calculating unit 102e calculates the degree centrality, betweenness centrality, closeness centrality, and Burt's constraint of the proteins that the protein-protein interaction network (PPI) includes (step SC-5).

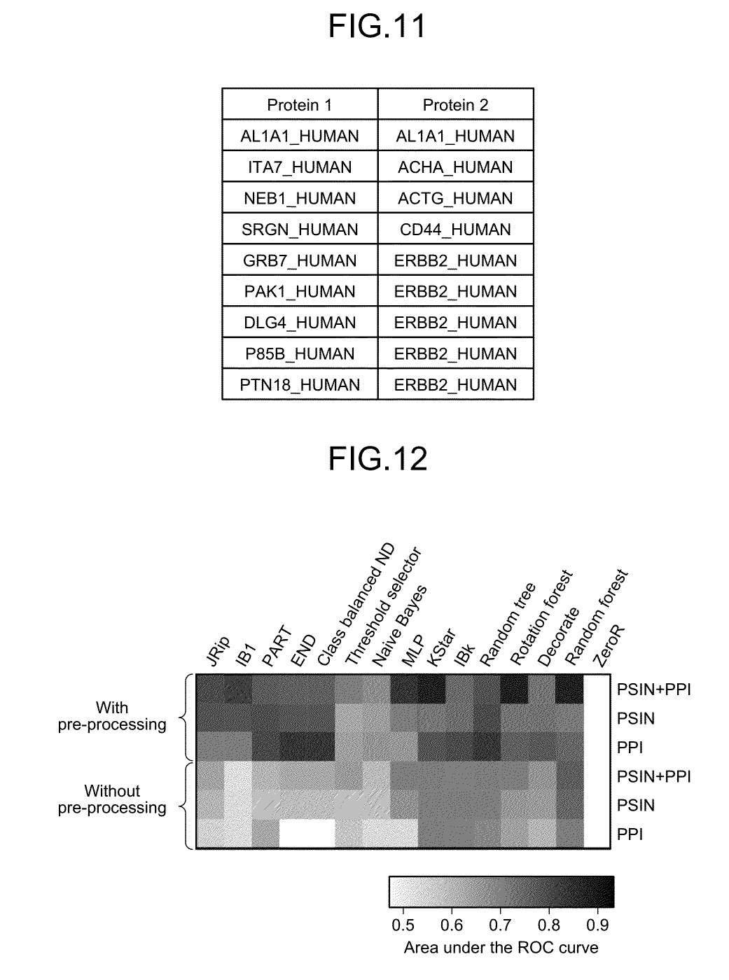

With reference to FIG. 11, exemplary interaction network information according to the embodiment will be explained. FIG. 11 is a diagram of the exemplary interaction network information according to the embodiment.

As shown in FIG. 11, the interaction network information according to the embodiment may contain a list of sets of proteins that physically interact with each other.

The following refers back to FIG. 4. The rejection score calculating unit 102f calculates a rejection score that represents probability that a compound to be validated is classified as a rejected drug, using machine learning classifiers that use, as training data, the approval attributes of each drug stored in the drug target database 106c, the sum and average of the degree centrality, betweenness centrality, closeness centrality, and Burt's constraint per target for each drug that are calculated by the similarity centrality measure calculating unit 102b at step SC-2, and the sum and average of the degree centrality, betweenness centrality, closeness centrality, and Burt's constraint per target for each drug that are calculated by the interaction centrality measure calculating unit 102e at step SC-5 (step SC-6). The drug target database 106c reports that most existing drugs (compounds) bind and inhibit the activity of several proteins at once, i.e., reports several drug targets, and hence, it is necessary to consider the centrality measures of all proteins targeted by each compound. The rejection score calculating unit 102f thus calculates, using the protein similarity network (PSIN) and protein-protein interaction network (PPI), the sum and average of the degree centrality, betweenness centrality, closeness centrality, and Burt's constraint per target for each drug and uses eight attributes from the PSIN, eight attributes from the PPI, and one attribute indicating the class of the (approved or rejected) compound as a final data set to be input to the classifiers. The machine learning classifiers may be a set of machine learning classifiers, such as an existing package (Wishart, 2006) like WEKA.

According to the embodiment, using the machine learning classification and classification of (approved and rejected) drugs as a guide for the training and prediction steps, 10-fold cross validation is used to process the final data set. Additionally, according to the embodiment, this step is performed using several different classification algorithms and it is verified that the prediction performance is enhanced in two cases: when pre-processing techniques are used and when centrality measures from the protein similarity network (PSIN) and centrality measures from the protein-protein interaction network (PPI) are used for the same dataset.

The pre-processing according to the embodiment may be performed in the following three steps. It is necessary to first fill the missing values with a unit and mode of the other instances of the synthesized dataset, second increase the number of instances in the smaller class, and finally sample the dataset. It is necessary to collect more samples from samples for much smaller classes because the dataset according to the embodiment is composed of several instances of the approved class and only ˜300 examples of the rejected (problematic) class. For this reason, in consideration for the development costs of a new compound, the inconvenience caused by misclassifying an approved drug as a problematic one is smaller than classifying a problematic drug as an approved one. Hence, according to the embodiment, the SMOTE algorithm may be used for over-sampling the smaller class and under-sampling the larger class. This strategy improves the performance of classifiers in datasets with varying sizes. To perform the second step that is resampling, instances may be randomly selected from the dataset, i.e., the same instance could be selected twice. Furthermore, the new dataset may have the same number of instances and attributes as that of the original dataset and there may be 50-60 unique instances.

With reference to FIG. 12, exemplary improvement of the performance of classifiers according to the embodiment will be explained. FIG. 12 is a graph of the exemplary improvement of the performance of classifiers according to the embodiment.

As shown in FIG. 12, regarding the classifiers according to the embodiment, it is possible to considerably improve the sensitivity of the classifiers to the class of problematic drugs by using the pre-processing techniques and using the centrality measures from the PSIN and the centrality measures from the PPI for the same data set.

Furthermore, according to the embodiment, a comparison is made for the prediction power between 15 machine learning classifiers using three different strategies. In a first method, a comparison is made using 10-fold cross validation. In a second method, a comparison is made, dividing the original dataset into a training set and a test set with 70% and 35% of instances, respectively. In the embodiment, drugs are randomly selected for 500 times to make an adjustment to diminish unevenness. When dividing the dataset into a training set and a test set, only the training set is pre-processed.

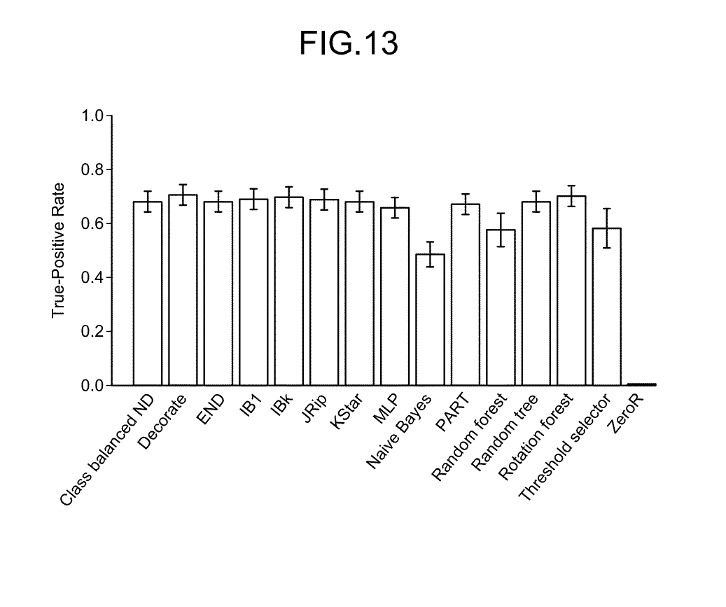

With reference to FIG. 13, exemplary accuracy of classification performed by classifiers according to the embodiment will be explained. FIG. 13 is a graph of the exemplary accuracy of classification performed by classifiers according to the embodiment.

As shown in FIG. 13, for practically measuring the accuracy of the classifiers according to the embodiment, a harmonic mean of the true positive rates for the approved class or problematic class for drugs is used. As shown in FIG. 13, because most classifiers have the same performance (because of optimization of parameters and use of the pre-processing technique), in the embodiment, seven algorithms (such as KSTAR, IBK, Decorate, END ClassBalancedND, JRip and RotationForest) constructed using different principles and implementing best performances are used in order for further safeness prediction of drugs and for the purpose of correcting the biases that all algorithms necessarily have.

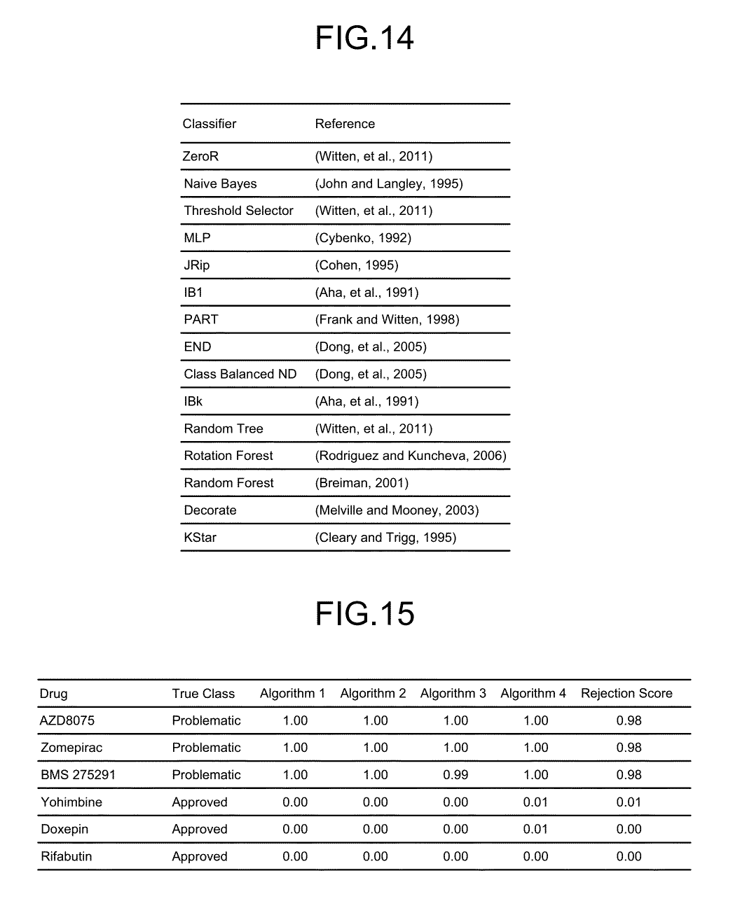

With reference to FIG. 14, exemplary classifiers according to the embodiment will be explained. FIG. 14 is a table of the exemplary classifiers according to the embodiment.

As shown in FIG. 14, because it is verified that KStar, Decorate, Rotation Forest and Random Forest have best performances regardless of whether the original data set is adjusted, these best four algorithms are used for further analysis in the embodiment. During the test phase, when the classifiers categorize instances that have not been detected, these seven optimum algorithms calculate probabilities of each drug belonging to the problematic class and, using the calculated probabilities, create an index, named “rejection score” (RS). According to the embodiment, the value obtained by averaging these probabilities using the contra harmonic mean may be an RS. The value of RS may indicate whether a compound is predicted to be safe (RS close to 0.0) or harmful (RS close to 1.0).

The following refers back to FIG. 4. The rejection score outputting unit 102g displays the rejection score of the compound calculated by the rejection score calculating unit 102f on the display unit 112 (step SC-7) and ends the processing. The rejection score outputting unit 102g may output the rejection score via a print output unit.

With reference to FIG. 15, exemplary output information according to the embodiment will be explained. FIG. 15 is a diagram of the exemplary output information according to the embodiment.

As shown in FIG. 15, the rejection score outputting unit 102g may output a list of drugs and their respective rejection scores (values between 0.00 and 1.00). While problematic drugs have score values close to 1.00, approved drugs have scores close to 0.00. FIG. 15 depicts examples obtained by inputting existing drugs obtained from the Drugbank database. By inputting compounds of interest that could be drug candidates, users can check the rejection score of the standard protein and the compounds. With the method according to the embodiment, the effectiveness of the proposed methodology is verified by accurately distinguishing between existing 1000 approved and rejected drugs.

The explanation of the exemplary processing performed by the approval prediction apparatus 100 according to the embodiment ends here.

### Other Embodiments

The embodiment of the present invention is explained above. However, the present invention may be implemented in various different embodiments other than the embodiment described above within a technical scope described in claims.

For example, an example in which the approval prediction apparatus 100 performs the processing as a standalone apparatus is explained. However, the approval prediction apparatus 100 can be configured to perform processes in response to request from a client terminal (having a housing separate from the approval prediction apparatus 100) and return the process results to the client terminal.

All the automatic processes explained in the present embodiment can be, entirely or partially, carried out manually. Similarly, all the manual processes explained in the present embodiment can be, entirely or partially, carried out automatically by a known method.

The process procedures, the control procedures, specific names, information including registration data for each process and various parameters such as search conditions, display example, and database construction, mentioned in the description and drawings can be changed as required unless otherwise specified.

The constituent elements of the approval prediction apparatus 100 are merely conceptual and may not necessarily physically resemble the structures shown in the drawings.

For example, the process functions performed by each device of the approval prediction apparatus 100, especially each of the process functions performed by the control unit 102, can be entirely or partially realized by a CPU and a computer program executed by the CPU or by a hardware using wired logic. The computer program, recorded on a non-transitory tangible computer readable recording medium including programmed commands for causing a computer to execute the method of the present invention, can be mechanically read by the approval prediction apparatus 100 as the situation demands. In other words, the storage unit 106 such as read-only memory (ROM) or hard disk drive (HDD) stores the computer program that can work in coordination with an operating system (OS) to issue commands to the CPU and cause the CPU to perform various processes. The computer program is first loaded to the random access memory (RAM), and forms the control unit in collaboration with the CPU.

Alternatively, the computer program can be stored in any application program server connected to the approval prediction apparatus 100 via the arbitrary network 300, and can be fully or partially loaded as the situation demands.

The computer program may be stored in a computer-readable recording medium, or may be structured as a program product. Here, the “recording medium” includes any “portable physical medium” such as a memory card, a USB (Universal Serial Bus) memory, an SD (Secure Digital) card, a flexible disk, an optical disk, a ROM, an EPROM (Erasable Programmable Read Only Memory), an EEPROM (Electronically Erasable and Programmable Read Only Memory), a CD-ROM (Compact Disk Read Only Memory), an MO (Magneto-Optical disk), a DVD (Digital Versatile Disk), and a Blu-ray Disc.

Computer program refers to a data processing method written in any computer language and written method, and can have software codes and binary codes in any format. The computer program can be in a dispersed form in the form of a plurality of modules or libraries, or can perform various functions in collaboration with a different program such as the OS. Any known configuration in each of the devices according to the embodiment can be used for reading the recording medium. Similarly, any known process procedure for reading or installing the computer program can be used.

Various databases (the protein sequence information database 106a, the similarity network information database 106b, the drug target database 106c, and the interaction network information database 106d) stored in the storage unit 106 are storage units such as a memory device such as a RAM or a ROM, a fixed disk device such as a HDD, a flexible disk, and an optical disk, and stores therein various programs, tables, databases, and web page files used for providing various processing or web sites.

The approval prediction apparatus 100 may be structured as an information processing apparatus such as known personal computers or workstations, or may be structured by connecting any peripheral devices to the information processing apparatus. Furthermore, the approval prediction apparatus 100 may be realized by mounting software (including programs, data, or the like) for causing the information processing apparatus to implement the method according to the invention.

The distribution and integration of the device are not limited to those illustrated in the figures. The device as a whole or in parts can be functionally or physically distributed or integrated in an arbitrary unit according to various attachments or how the device is to be used. That is, any embodiments described above can be combined when implemented, or the embodiments can selectively be implemented.

### INDUSTRIAL APPLICABILITY

As described above, according to the present invention, it is possible to provide an approval prediction apparatus, an approval prediction method, and a program that allow to quantify the probability of approval or rejection of drugs, and accordingly it is extremely useful in various fields including medical treatments, pharmaceutics, drug discoveries, and biological researches.

### EXPLANATION OF LETTERS OR NUMERALS

100 APPROVAL PREDICTION APPARATUS
102 CONTROL UNIT
102a SIMILARITY NETWORK INFORMATION STORING UNIT
102b SIMILARITY CENTRALITY MEASURE CALCULATING UNIT
102c APPROVAL DETERMINING UNIT
102d DETERMINATION RESULT OUTPUTTING UNIT
102e INTERACTION CENTRALITY MEASURE CALCULATING UNIT
102f REJECTION SCORE CALCULATING UNIT
102g REJECTION SCORE OUTPUTTING UNIT
104 COMMUNICATION CONTROL INTERFACE UNIT
106 STORAGE UNIT
106a PROTEIN SEQUENCE INFORMATION DATABASE
106b SIMILARITY NETWORK INFORMATION DATABASE
106c DRUG TARGET DATABASE
106d INTERACTION NETWORK INFORMATION DATABASE
108 INPUT/OUTPUT CONTROL INTERFACE UNIT
112 DISPLAY UNIT
114 INPUT UNIT
200 EXTERNAL SYSTEM
300 NETWORK

1. An approval prediction apparatus comprising an output unit, a storage unit, and a control unit, wherein
the storage unit includes:
a similarity network information storage unit that stores similarity network information on a protein similarity network that is constructed according to the similarity between proteins;
a drug target storage unit that stores drug information containing approval attributes of drugs on approval or rejection and protein information on the proteins targeted by the drugs in association with each other; and
an interaction network information storage unit that stores interaction network information on a protein-protein interaction network that is constructed based on interactions between the proteins; and
the control unit includes:
a similarity centrality measure calculating unit that, based on the similarity network information stored in the similarity network information storage unit, calculates similarity centrality measures that are centrality measures containing the degree centrality, betweenness centrality, closeness centrality, and Burt's constraint of the proteins that the protein similarity network includes;
an interaction centrality measure calculating unit that, based on the interaction network information stored in the interaction network information storage unit, calculates interaction centrality measures that are centrality measures containing the degree centrality, betweenness centrality, closeness centrality, and Burt's constraint of the proteins that the protein-protein interaction network includes;
a rejection score calculating unit that calculates a rejection score that represents probability of a compound to be validated to be classified as a rejected drug, using classifiers that use, as training data, the approval attributes of the respective drugs stored in the drug target storage unit, the sum and average of the similarity centrality measures per target for each drug that are calculated by the similarity centrality measure calculating unit, and the sum and average of the interaction centrality measures per target for each drug that are calculated by the interaction centrality measure calculating unit; and
a rejection score outputting unit that outputs, via the output unit, the rejection score that is calculated by the rejection score calculating unit.

2. An approval prediction apparatus comprising an output unit, a storage unit, and a control unit, wherein
the storage unit includes:
a similarity network information storage unit that stores similarity network information on a protein similarity network that includes proteins having similarity; and
a drug target storage unit that stores drug information containing approval attributes of drugs on approval or rejection and protein information on the proteins targeted by the drugs in association with each other; and
the control unit includes:
a similarity centrality measure calculating unit that, based on the similarity network information stored in the similarity network information storage unit, calculates similarity centrality measures that are centrality measures containing the degree centrality, betweenness centrality, closeness centrality, and Burt's constraint of the proteins that the protein similarity network includes;
an approval determining unit that, based on the approval attributes of the drugs targeting the proteins according to the protein information stored in the drug target storage unit, which are the proteins that the protein similarity network includes, obtains a determination result representing whether the proteins to be validated, which are proteins that the similarity network includes, are within a range of targets of approved drugs or a range of targets of rejected drugs, using the similarity centrality measures of the proteins to be validated that are calculated by the similarity centrality measure calculating unit; and
a determination result outputting unit that outputs, via the output unit, the determination result that is obtained by the approval determining unit.

3. The approval prediction apparatus according to claim 1, wherein
the storage unit further includes a protein sequence information storage unit that stores sequence information on amino acid sequences of the proteins, and
the control unit further includes a similarity network information storing unit that, when the similarity is detected between the proteins using a signature-based algorithm and based on the sequence information stored in the protein sequence information storage unit, creates the protein similarity network including the proteins between which the similarity is detected and stores the similarity network information on the protein similarity network in the similarity network information storage unit.

4. The approval prediction apparatus according to claim 2, wherein, based on the approval attributes of the drugs targeting the proteins according to the protein information stored in the drug target storage unit, which are the proteins that the protein similarity network includes, the approval determining unit generates a determination result representing that the proteins to be validated are within the range of targets of rejected drugs when the degree centrality contained in the similarity centrality measures of the proteins to be validated that are calculated by the similarity centrality measure calculating unit is high, the closeness centrality is low, and the Burt's constraint is extremely low.

5. An approval prediction method executed by an approval prediction apparatus including an output unit, a storage unit, and a control unit, wherein
the storage unit includes:
a similarity network information storage unit that stores similarity network information on a protein similarity network that is constructed according to the similarity between proteins;
a drug target storage unit that stores drug information containing approval attributes of drugs on approval or rejection and protein information on the proteins targeted by the drugs in association with each other; and
an interaction network information storage unit that stores interaction network information on a protein-protein interaction network that is constructed based on interactions between the proteins;
the method executed by the control unit comprising:
a similarity centrality measure calculating step of, based on the similarity network information stored in the similarity network information storage unit, calculating similarity centrality measures that are centrality measures containing the degree centrality, betweenness centrality, closeness centrality, and Burt's constraint of the proteins that the protein similarity network includes;
an interaction centrality measure calculating step of, based on the interaction network information stored in the interaction network information storage unit, calculating interaction centrality measures that are centrality measures containing the degree centrality, betweenness centrality, closeness centrality, and Burt's constraint of the proteins that the protein-protein interaction network includes;
a rejection score calculating step of calculating a rejection score that represents probability of a compound to be validated to be classified as a rejected drug, using classifiers that use, as training data, the approval attributes of the respective drugs stored in the drug target storage unit, the sum and average of the similarity centrality measures per target for each drug that are calculated at the similarity centrality measure calculating step, and the sum and average of the interaction centrality measures per target for each drug that are calculated at the interaction centrality measure calculating step; and
a rejection score outputting step of outputting, via the output unit, the rejection score that is calculated at the rejection score calculating step.

6. An approval prediction method executed by an approval prediction apparatus including an output unit, a storage unit, and a control unit, wherein
the storage unit includes:
a similarity network information storage unit that stores similarity network information on a protein similarity network that includes proteins having similarity; and
a drug target storage unit that stores drug information containing approval attributes of drugs on approval or rejection and protein information on the proteins targeted by the drugs in association with each other; and
the method executed by the control unit includes:
a similarity centrality measure calculating step of, based on the similarity network information stored in the similarity network information storage unit, calculating similarity centrality measures that are centrality measures containing the degree centrality, betweenness centrality, closeness centrality, and Burt's constraint of the proteins that the protein similarity network includes;
an approval determining step of, based on the approval attributes of the drugs targeting the proteins according to the protein information stored in the drug target storage unit, which are the proteins that the protein similarity network includes, obtaining a determination result representing whether the proteins to be validated, which are proteins that the similarity network includes, are within a range of targets of approved drugs or a range of targets of rejected drugs, using the similarity centrality measures of the proteins to be validated that are calculated at the similarity centrality measure calculating step; and
a determination result outputting step of outputting, via the output unit, the determination result that is obtained at the approval determining step.

7. A computer program product having a non-transitory tangible computer readable medium including programmed instructions for causing, when executed by an approval prediction apparatus including an output unit, a storage unit, and a control unit, wherein
the storage unit includes:
a similarity network information storage unit that stores similarity network information on a protein similarity network that is constructed according to the similarity between proteins;
a drug target storage unit that stores drug information containing approval attributes of drugs on approval or rejection and protein information on the proteins targeted by the drugs in association with each other; and
an interaction network information storage unit that stores interaction network information on a protein-protein interaction network that is constructed based on interactions between the proteins;
the approval prediction apparatus to perform an approval prediction method comprising:
a similarity centrality measure calculating step of, based on the similarity network information stored in the similarity network information storage unit, calculating similarity centrality measures that are centrality measures containing the degree centrality, betweenness centrality, closeness centrality, and Burt's constraint of the proteins that the protein similarity network includes;
an interaction centrality measure calculating step of, based on the interaction network information stored in the interaction network information storage unit, calculating interaction centrality measures that are centrality measures containing the degree centrality, betweenness centrality, closeness centrality, and Burt's constraint of the proteins that the protein-protein interaction network includes;
a rejection score calculating step of calculating a rejection score that represents probability of a compound to be validated to be classified as a rejected drug, using classifiers that use, as training data, the approval attributes of the respective drugs stored in the drug target storage unit, the sum and average of the similarity centrality measures per target for each drug that are calculated at the similarity centrality measure calculating step, and the sum and average of the interaction centrality measures per target for each drug that are calculated at the interaction centrality measure calculating step; and
a rejection score outputting step of outputting, via the output unit, the rejection score that is calculated at the rejection score calculating step.

8. A computer program product having a non-transitory tangible computer readable medium including programmed instructions for causing, when executed by an approval prediction apparatus including an output unit, a storage unit, and a control unit, wherein
the storage unit includes:
a similarity network information storage unit that stores similarity network information on a protein similarity network that includes proteins having similarity; and
a drug target storage unit that stores drug information containing approval attributes of drugs on approval or rejection and protein information on the proteins targeted by the drugs in association with each other;
the approval prediction apparatus to perform an approval prediction method comprising:
a similarity centrality measure calculating step of, based on the similarity network information stored in the similarity network information storage unit, calculating similarity centrality measures that are centrality measures containing the degree centrality, betweenness centrality, closeness centrality, and Burt's constraint of the proteins that the protein similarity network includes;
an approval determining step of, based on the approval attributes of the drugs targeting the proteins according to the protein information stored in the drug target storage unit, which are the proteins that the protein similarity network includes, obtaining a determination result representing whether the proteins to be validated, which are proteins that the similarity network includes, are within a range of targets of approved drugs or a range of targets of rejected drugs, using the similarity centrality measures of the proteins to be validated that are calculated at the similarity centrality measure calculating step; and
a determination result outputting step of outputting, via the output unit, the determination result that is obtained at the approval determining step.
